(19) United States
(12) Patent Application Publication
(10) Pub. No.: US 2014/0077402 A1
(43) Pub. Date: Mar. 20, 2014

(54) HUMIDIFICATION CELL

(71) Applicant: SIEMENS AKTIENGESELLSCHAFT, MUENCHEN (DE)

(72) Inventors: Torsten Brandt, Forchheim (DE); Armin Datz, Poxdorf (DE); Albert Hammerschmidt, Erlangen (DE); Joachim Hoffmann, Burgthann (DE); Silke Latzel, Kleinsendelbach (DE); Arno Mattejat, Erlangen (DE)

(73) Assignee: SIEMENS AKTIENGESELLSCHAFT, MUENCHEN (DE)

(21) Appl. No.: 14/118,616

(22) PCT Filed: Apr. 16, 2012
(86) PCT No.: PCT/EP2012/056889

§ 371 Date: Nov. 19, 2013

(30) Foreign Application Priority Data
May 19, 2011 (EP) 11166699.6

(51) Int. Cl. H01M 8/04

(52) U.S. Cl. CPC H01M 8/04149
USPC 261/100

(57) ABSTRACT

A humidification cell of a fuel cell apparatus includes a first outer plate and a second outer plate. A gas chamber, a humidification water chamber, and a water-permeable membrane that separates the two chambers are disposed between the first outer plate and the second outer plate starting from the first outer plate. A first water-permeable support element is disposed between the first outer plate and the membrane. The first support element is made of a woven fabric formed of a plastic. A discharge and an entrainment of liquid water can be prevented during load changes or other non-stationary fuel cell operating states accompanied by a sudden change of gas volume flow in that the plastic is a fluoropolymer or a fluoroplastic. Advantageously, the fluoropolymer or fluoroplastic is formed at least partly, preferably entirely, of an alternating copolymer of ethylene and chlorotrifluorethylene (E-CTFE).

The invention relates to a humidification cell according to the preamble of claim 1. A humidification cell of said type is known for example from WO 2009/101036 A1.

In a fuel cell, electric current is generated at a high level of efficiency by means of the electrochemical combination of hydrogen (H₂) and oxygen (O₂) at an electrode to form water (H₂O). The industrial implementation of this fuel cell principle has led to different solutions, specifically using different electrolytes at operating temperatures between 60° C. and 1000° C. As a function of their operating temperature, the fuel cells are classified into low-, medium- and high-temperature fuel cells, which are in turn differentiated from one another by different technical embodiments.

During their operation the fuel cells of a fuel cell array are supplied with operating gases, i.e. a hydrogen-containing fuel gas and an oxygen-containing oxidation gas. Some embodiment variants of low-temperature fuel cells, in particular fuel cells having a polymer electrolyte membrane (PEM fuel cells), require humidified operating gases for their operation. Said operating gases are saturated with steam in a suitable apparatus, such as a liquid ring compressor or a membrane humidifier, for example. In combination with the fuel cell array, the humidification apparatus and possible further supply apparatuses form a fuel cell apparatus.

If the operating gases are conducted from the humidifier to the fuel cell array through long operating gas supply lines, the temperature of a humidified operating gas can in this way be lowered through loss of heat to the environment. This leads to the condensation of humidification water. The operating gases are subsequently reheated in the fuel cells, whereby their relative humidity is reduced. As a result, the electrolyte, which must be kept permanently moist and is extremely sensitive to dryness, can be damaged, thus reducing its service life. It is therefore desirable for the humidifier to be arranged as close as possible to the fuel cells.

A fuel cell block having a stack of planar fuel cells and a stack of planar humidification cells is known from EP 1 435 121 B1. The two stacks are arranged immediately adjacent to one another in the fuel cell block. The humidification cells are embodied as membrane humidifiers in which, starting from a first outer plate, a gas chamber, a humidification water chamber and a water-permeable membrane separating the two chambers are arranged between the first outer plate and a second outer plate, a water-permeable support element being arranged between the membrane and the first outer plate.

Before the operating gases are supplied to the fuel cells of the fuel cell stack, they flow through the humidification cells, are humidified there and then flow, without leaving the fuel cell block again, into the fuel cell stack.

The humidification water flows in the humidification water chamber, i.e. on one side of the membrane, and the operating gas flows in the gas chamber, i.e. on the other side of the membrane, through channels which are incorporated into the respective outer plate. In order to prevent the membrane from being covered along webs of the outer plates by said webs, such that no humidification water or operating gas can reach the membrane, a water-permeable support element is arranged in each case between the membrane and one or both of the outer plates.

By this means the membrane is held spaced at a distance from the outer plate in the region of the support element and it is thus ensured that humidification water or operating gas can infiltrate up to the membrane over an extensive area, thereby increasing the humidification capacity. This is particularly important when using large-area structures in the outer plate. Depending on the side of the membrane on which the support element is arranged, the humidification water penetrates either firstly the support element and then the membrane or firstly the membrane and then the support element, and in this way reaches the operating gas that is to be humidified.

In this case at least the support element between the membrane and the second outer plate advantageously consists of carbon paper. The carbon paper is stable with respect to the operating media used or the membrane material and preferably has hydrophilic characteristics, i.e. is completely wetted by the water. Owing to its hydrophilic properties and large surface area, the carbon paper ensures good humidification and any water droplets possibly resulting due to the hydrostatic pressure are distributed over the surface and entrained in gaseous form in the gas chamber by the gas flow. The mechanical forces between the membrane and the outer plate(s) are absorbed well by the carbon paper, and direct contact between the membrane and the outer plate(s), and consequently corrosion, is furthermore avoided.

It is known from WO 2009/101036 A1 to use a fabric consisting of a plastic, instead of carbon paper, in a humidification cell of said type. Good gas humidification can also be achieved by this means, without liquid water in the form of water droplets being entrained on a large scale by the operating gas in the gas chamber, which can lead to restrictions in terms of the functional capability of fuel cells due to the introduction of water.

It is the object of the present invention to improve the operating characteristics of a humidification cell of said type even further. At the same time the humidification cell is also intended to be suitable in particular for operation involving abrupt changes in the gas volume flow, as caused for example by load changes at the fuel cells.

This object is successfully achieved by means of a humidification cell having the features recited in claim 1. Advantageous embodiments are the subject matter of the respective dependent claims.

According to the invention, the fabric of the first support element is formed from a fluoropolymer which consists at least partially, preferably completely, of an alternating copolymer made of ethylene and chlorotrifluoroethylene (E-CTFE). As has been shown, fabrics of said type are characterized by good resistance against the operating gases of fuel cells (in particular against oxygen), a sufficiently large surface for the gas humidification, and a good retention/storage capacity for water (hydrophilic properties). In particular, however, they can also be provided with very good wetting characteristics for liquid water. This enables a discharge and entrainment of liquid water during load changes or other non-stationary operating states of the fuel cells, which are associated with an abrupt change in the gas volume flow, to be avoided. This prevents some of the water adhering on the surface of the fabric in liquid form from being entrained and traveling from the humidifier zone into the fuel cells, where voltage drops can occur.

By virtue of their mechanical properties (deformability, strength) these materials are able to absorb the mechanical forces arising during the operation of the humidification cell without suffering damage or damaging the neighboring components.

It is furthermore of importance that a fabric of said type can be furnished with such flexibility in mechanical terms that it spreads itself very evenly onto the membrane, thereby likewise establishing good behavioral characteristics in the event of an abrupt change in the gas volume flow as a result of a load change.

The above-explained properties of good resistance against the fuel cell operating gases, in particular against oxygen, good humidification capacity and good behavioral characteristics during load changes are optimally fulfilled by a fabric in which the fluoropolymer consists at least partially, preferably completely, of an alternating copolymer made of ethylene and chlorotrifluoroethylene (E-CTFE).

Preferably there is arranged between the membrane and the second outer plate a second water-permeable support element which is likewise preferably manufactured from a fabric consisting of a fluoropolymer. This enables the membrane to be maintained particularly reliably in a desired position.

According to an advantageous embodiment, the fluoropolymer is calandered, i.e. has been produced by means of a calandering process.

The good mechanical properties can be achieved above all if the fabric has a twill weave or twill structure (also referred to as “twill” for short).

According to another advantageous embodiment, the fabric has an air permeability of 220 to 300 l/m²s at 2 mbar, in particular of 260 l/m²s at 2 mbar.

The fabric is preferably 200 to 500 μm thick, in particular 370 μm.

In this case the fabric is advantageously matched in terms of its thickness and the diameter of its pores to the rigidity of the membrane and to the pressures in the chambers adjoining the membrane such that during the operation of the humidification cell, even in the event of load changes in the fuel cells, the membrane does not squeeze through the pores and come into contact with the outer plate. By this means it is possible to avoid degradations in humidification performance and corrosion problems in the case of metallic outer plates. In spite of pores, the fabric is then similarly “leakproof” to a corresponding carbon paper.

Particularly stable mounting of the membrane and a particularly simple structure of the humidification cell are achieved in that the first outer plate, the first support element, the membrane, the second support element and the second outer plate in each case butt against one another. In this arrangement the outer plates beneficially have channels or projections through which the operating gas or the humidification water can flow along the outer plate and along the support element butting against the outer plate. In this embodiment the humidification cell forms a particularly stable composite structure that is largely insensitive to pressure. This embodiment of the invention is particularly suitable in the case of very flat humidification cells having a very flat gas chamber and/or humidification water chamber.

The support element can completely cover the area of the membrane that is accessible to the humidification water or to the operating gas. Good support for the membrane is also ensured, however, if the support element covers only part of the flat side of the membrane, for example as a result of recesses in the support element. This gives the humidification water and operating gas unobstructed access to the membrane, thereby increasing the humidification capacity of the humidification cell.

Exemplary embodiments of the invention are explained in more detail with reference to five figures, in which:

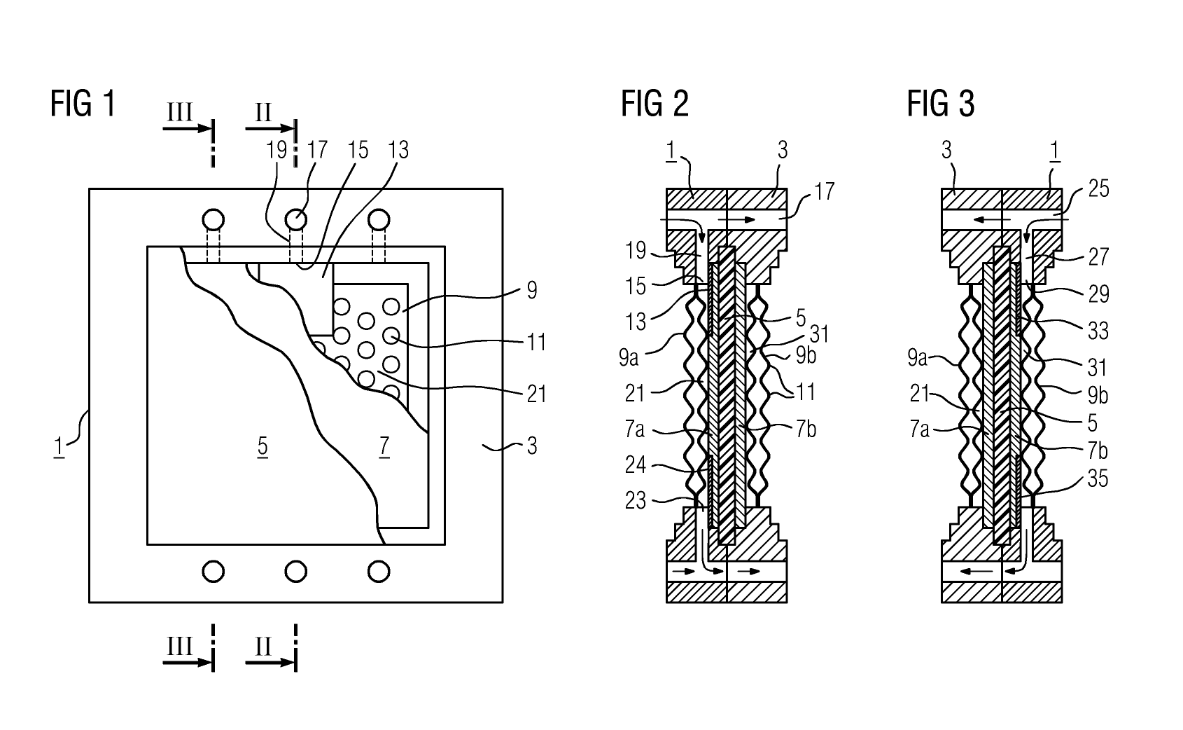

FIG. 1 shows a plan view of a humidification cell in a cutaway representation;

FIG. 2 shows a section through the humidification cell from FIG. 1;

FIG. 3 shows a further section through the humidification cell of FIG. 1;

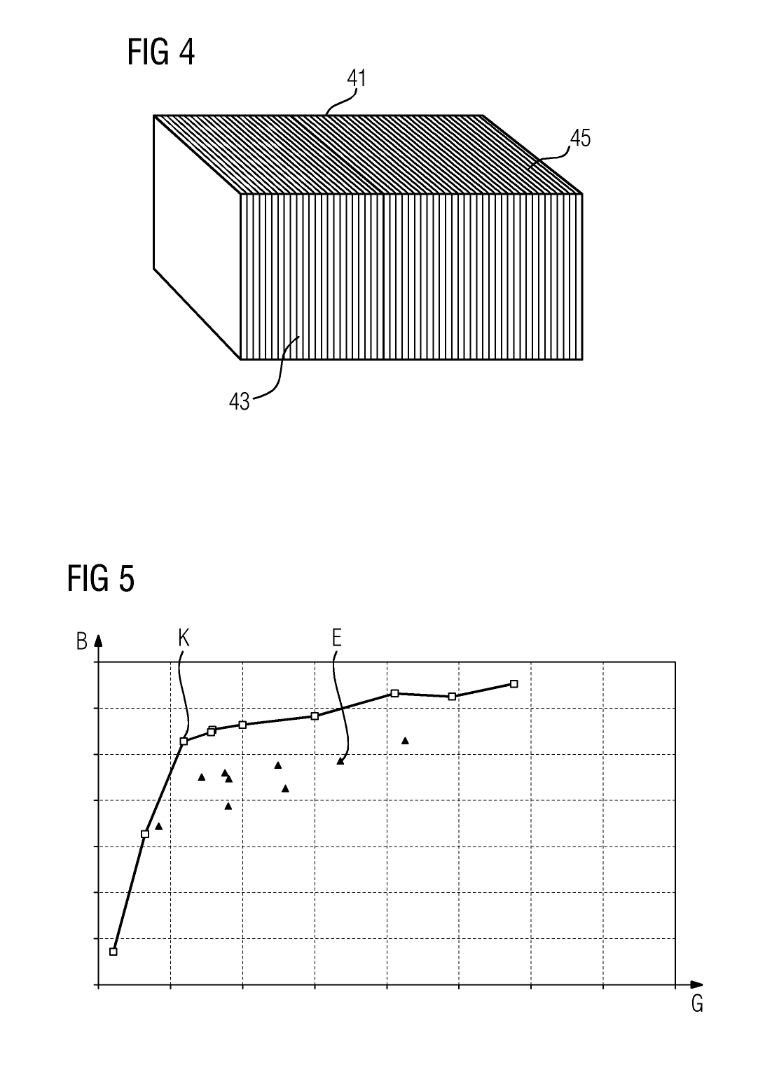

FIG. 4 shows a fuel cell apparatus;

FIG. 5 shows a measurement of the humidification capacity for a fabric made of E-CTFE in comparison with carbon paper;

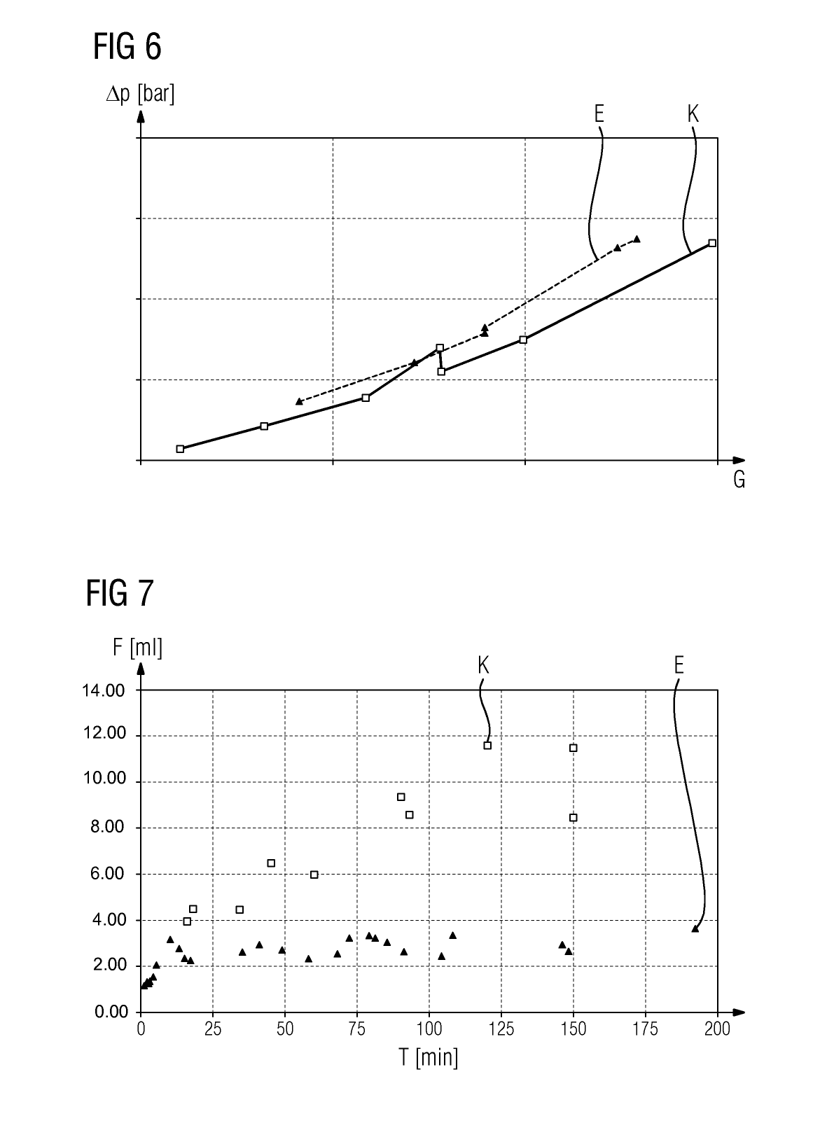

FIG. 6 shows a measurement of the pressure losses for a fabric made of E-CTFE in comparison with carbon paper; and

FIG. 7 shows the liquid water fraction at the outlet of a humidifier during a load jump.

Like objects are labeled with the same reference signs in the figures.

FIG. 1 is a schematic plan view of the basic structure of a rectangular and planar humidification cell 1 which comprises a membrane 5 embedded in a frame of a sealing material 3, shown in a cutaway representation. Under the membrane 5 can be seen a support element 7, likewise shown in a cutaway representation. Shown under the support element 7 is an outer plate 9 which is embodied in the form of a metal sheet with an embossed structure 11. The embossed structure 11 consists of round elevations or depressions within the outer plate 9. A covering device 13 is installed between the outer plate 9 and the support element 7. The covering device 13 is arranged in the region of an operating medium inlet 15.

FIG. 2 shows a section through the humidification cell 1 along the line II-II, though now a support element 7a or 7b and an outer plate 9a or 9b, respectively, are arranged on either side of the membrane 5. In detail, the humidification cell 1 comprises a first outer plate 9a and a second outer plate 9b. Starting from the first outer plate 9a, a gas chamber 21, a humidification water chamber 31 and the water-permeable membrane 5 separating the two chambers 21, 31 are arranged between the first outer plate 9a and the second outer plate 9b. A first water-permeable support element 7a is arranged between the first outer plate 9a and the membrane 5 and a second water-permeable support element 7b is arranged between the second outer plate 9b and the membrane 5.

The humidification cell 1 is part of a humidification cell stack of a fuel cell apparatus. During operation of the humidification cell 1, fuel gas flows through the axial channel 17 of the humidification cell 1. The axial channel 17 is aligned parallel to the stacking direction of the humidification cell stack. From the axial channel 17, one radial channel 19 in each case branches off to one of the humidification cells 1 of the humidification cell stack. The fuel gas flows through the radial channel 19, continues on its way through the operating medium inlet 15, and then enters the gas chamber 21 of the humidification cell 1. After exiting the operating medium inlet 15, the fuel gas, without creating significant turbulence, flows along the covering device 13 on one side and along the outer plate 9 of the humidification cell 1 on the other side.

The first outer plate 9a is embodied in the form of a heating element which is composed of two metal sheets. Located between the metal sheets is a heating water chamber through which hot heating water flows during operation of the humidification cell 1. Said heating water heats both the fuel gas flowing through the humidification cell 1 and the humidification water to approximately the temperature of the fuel cells of the fuel cell apparatus.

In the gas chamber 21, the fuel gas is humidified with humidification water and, after flowing through the gas chamber 21, reaches the operating medium outlet 23 of the gas chamber 21. Flowing through a further radial channel and a further axial channel, it exits the humidification cell 1 again in the humidified state. In the region of the operating medium outlet 23 also, the support element 7a is covered by a further covering device 24 in order to prevent turbulence when the fuel gas flows into the operating medium outlet 23.

FIG. 3 shows a section through the humidification cell 1 along the line III-III shown in FIG. 1, with in this case too a support element 7a or 7b and an outer plate 9a or 9b, respectively, now being arranged in each case on either side of the membrane 5. This section is taken along an axial channel 25 which guides humidification water during the operation of the humidification cell 1. The humidification water flows through the axial channel 25 and passes through the radial channel 27 to arrive at a further operating medium inlet 29. Flowing through said operating medium inlet 29, the humidification water reaches the humidification water chamber 31 and flows between the second outer plate 9b and a covering device 33. The humidification water then reaches the second support element 7b.

Part of the humidification water penetrates the second support element 7b and reaches the membrane 5. After passing through said water-permeable membrane 5, the humidification water also penetrates the first support element 7a arranged on the other side of the membrane 5. On the side of the support element 7a facing toward the gas chamber 21, the humidification water evaporates, thus humidifying the fuel gas flowing through the gas chamber 21. A further part of the humidification water flows unused through the humidification water chamber 31, sweeps along a further covering device 35 and exits the humidification cell 1 again after flowing through a radial channel and a further axial channel.

The second outer plate 9b is also embodied in the form of a heating element which is composed of two metal sheets. Located between the metal sheets is a heating water chamber through which hot heating water flows during the operation of the humidification cell 1. Said heating water heats the humidification water flowing through the humidification water chamber 31 to approximately the temperature of the fuel cells of the fuel cell apparatus.

The two support elements 7a and 7b butt against the water-permeable membrane 5 in a detachable manner and cover the flat outsides of the membrane 5 completely except for a narrow outer edge. Together with the membrane 5, the two support elements 7a and 7b form a membrane arrangement which is clamped between the two outer plates 9a, 9b of the humidification cell 1. The support elements 7a, 7b thus butt against the membrane 5 on one side and against one of the outer plates 9a, 9b on the other side. The membrane 5 is held firmly in its position by the support elements 7a, 7b. The support elements 7a, 7b additionally prevent the membrane 5 from coming into contact with the outer plates 9a, 9b at any point and thus being covered by part of the outer plates 9a, 9b.

In this arrangement the support elements 7a, 7b consist of a fabric which is manufactured from an alternating copolymer made of ethylene and chlorotrifluoroethylene (E-CTFE) and has been calandered during the manufacturing process. The fabric has a twill weave. In addition, the fabric has an air permeability of 220 to 300 l/m²s at 2 mbar, in particular of 260 l/m²s at 2 mbar, with a thickness of 200 to 500 μm, in particular of 370 μm. A fabric of said type is available for example from the manufacturer Sefar under the name “Sefar Tetex® Mono 08-1050-K 039”.

In this case the fabric, in terms of its thickness and the diameter of its pores, and the membrane, in terms of its rigidity, are preferably matched to one another and to the pressure in the chambers adjoining the membrane such that the membrane does not squeeze through the pores during the operation of the humidification cell and come into contact with the outer plate.

FIG. 4 shows a schematic representation of a fuel cell apparatus 41 in the form of a fuel cell block. The fuel cell apparatus 41 comprises a stack of humidification cells 43 and a stack of fuel cells 45. The humidification cells 43 have the same width and height as the fuel cells 45. This means that the fuel cell block has a uniform width and height in the stacking direction of the humidification cells 43 and the fuel cells 45 along a stacking axis. In addition, the humidification cells 43 have the same thickness as the fuel cells 45, with the result that the external shape and the external dimensions of the humidification cells 43 are the same as the external shape and the external dimensions of the fuel cells 45.

Measurements of the current-voltage characteristic curves of the fuel cells, of the consumed humidification capacity and of the pressure losses when support elements 7a, 7b made of the above-explained E-CTFE fabric are used reveal only few differences in comparison with support elements 7a, 7b made of carbon paper, i.e. the operating characteristics of a humidification cell having support elements made of E-CTFE fabric are virtually comparable with the operating characteristics of a humidification cell having support elements made of carbon paper, with the added advantage that a detachment of carbon fibers and hence blockages at narrow gas passages for the media streams can be avoided.

FIG. 5 shows the humidification capacity B at the outlet of a humidifier consisting of four humidification cells, referred to the gas flow G during fuel cell operation for an outlet pressure of 2.6 bar when using carbon paper K and when using a fabric E made of E-CTFE.

FIG. 6 shows a measurement of the pressure losses Δp between humidifier inlet and outlet for a humidifier consisting of four humidification cells, referred to the gas flow G during fuel cell operation for an outlet pressure of 2.6 bar when using carbon paper K and when using a fabric E made of E-CTFE.

As can be seen from FIGS. 5 and 6, the humidification capacity in the case of the fabric E made of E-CTFE is only approx. 10% less than in the case of carbon paper K and the pressure losses are only about 10% greater than in the case of carbon paper K.

FIG. 7 shows the liquid water fraction F at the outlet of the humidifier during a load jump as a function of the operating time T prior to the load jump. As can be seen from FIG. 7, the liquid water fraction F is significantly less in the case of the fabric E made of E-CTFE than in the case of carbon paper K, the difference initially increasing sharply with increasing operating times and then remaining relatively constant.

1-8. (canceled)

9. A humidification cell of a fuel cell apparatus, the humidification cell comprising:
first and second outer plates;
a gas chamber;
a humidification water chamber;
a water-permeable membrane separating said gas chamber and said humidification water chamber;
said gas chamber, said water-permeable membrane and said humidification water chamber disposed in sequence starting from said first outer plate to said second outer plate; and
a first water-permeable support element disposed between said first outer plate and said membrane;
said first support element being manufactured from a fabric formed of a plastic, said plastic being a fluoropolymer formed partially or completely of an alternating copolymer made of ethylene and chlorotrifluoroethylene [E-CTFE].

10. The humidification cell according to claim 9, which further comprises a second water-permeable support element disposed between said membrane and said second outer plate, said second support element manufactured from a fabric formed of a plastic being a fluoropolymer.

11. The humidification cell according to claim 9, wherein said fluoropolymer is calandered.

12. The humidification cell according to claim 9, wherein said fabric has a twill weave.

13. The humidification cell according to claim 9, wherein said fabric has an air permeability of 220 to 300 l/m²s at 2 mbar.

14. The humidification cell according to claim 9, wherein said fabric has an air permeability of 260 l/m²s at 2 mbar.

15. The humidification cell according to claim 9, wherein said fabric has a thickness of 200 to 500 μm.

16. The humidification cell according to claim 9, wherein said fabric has a thickness of 370 μm.

17. The humidification cell according to claim 9, wherein:
said fabric has a thickness and pores with a diameter;
said membrane has a rigidity;
said gas chamber and said humidification water chamber have pressures; and
said thickness and said pore diameter of said fabric and said rigidity of said membrane are matched to one another and to said pressures in said gas chamber and said humidification water chamber to prevent said membrane from squeezing through said pores and coming into contact with said first outer plate during operation of the humidification cell.

18. The humidification cell according to claim 10, wherein:
said fabric has a thickness and pores with a diameter;
said membrane has a rigidity;
said gas chamber and said humidification water chamber have pressures; and
said thickness and said pore diameter of said fabric and said rigidity of said membrane are matched to one another and to said pressures in said gas chamber and said humidification water chamber to prevent said membrane from squeezing through said pores and coming into contact with said first and second outer plates during operation of the humidification cell.

19. The humidification cell according to claim 10, wherein said first outer plate, said first support element, said membrane, said second support element and said second outer plate respectively abut one another.
